(19) United States
(12) Patent Application Publication
(10) Pub. No.: US 2009/0157483 A1
(43) Pub. Date: Jun. 18, 2009

(54) Method and system for using artificial intelligence to generate or modify an employee prompt or a customer survey

(75) Inventors: Jonathan Otto, Palm Beach, FL (US); Andrew Van Luchene, Santa Fe, NM (US); Raymond J. Mueller, Palm Beach Gardens, FL (US); Michael R. Mueller, San Francisco, CA (US)

Correspondence Address: SIMPSON & SIMPSON, PLLC, 5555 MAIN STREET, WILLIAMSVILLE, NY, 14221-5406, US

(73) Assignee: RetailDNA, LLC, Lake Worth, FL (US)

(21) Appl. No.: 12/229,417

(22) Filed: Aug. 22, 2008

Related U.S. Application Data
(63) Continuation-in-part of application No. 12/151,043, filed on May 2, 2008.
Application No. 12/151,043 is a continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06Q 10/00

(52) U.S. Cl. 705/10

(57) ABSTRACT

A system for modifying a prompt or a survey, including: an interface element for at least one specially programmed general-purpose computer for receiving an audio input including: a response of an employee of a business entity to a prompt presented to the employee; or a response of a customer of the business entity to a question presented to the customer following a transaction between the customer and the business entity. The system also includes: a memory unit for the computer storing an artificial intelligence program (AIP); and a processor for the computer for: storing the audio input in the memory unit; comparing the audio input to a metric; modifying the prompt or the question using the AIP and the audio input comparison; and transmitting, using the interface element, the prompt or the question for presentation, on a respective display device, to the employee or the customer.

### CROSS-REFERENCE TO RELATED APPLICATIONS

This is a continuation-in-part patent application under 35 USC 120 U.S. patent application Ser. No. 12/151,043, filed May 2, 2008 and entitled “Method and System For Centralized Generation of a Business Executable Using Genetic Algorithms and Rules Distributed Among Multiple Hardware Devices,” which is a continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule and/or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to a method and system for automatically and intelligently generating and modifying employee prompts and customer surveys with respect to a defined metric to optimize a business parameter.

### BACKGROUND OF THE INVENTION

It is known to provide prompts to employees and surveys to customers, for example, as described in commonly owned U.S. Pat. No. 6,567,787, incorporated by reference herein. Unfortunately, such known means are not automatically adaptable.

Thus, there is a long-felt need to provide a system and a method to intelligently and automatically provide employee prompts and customer surveys with respect to a defined metric to optimize parameters associated with a business entity.

### SUMMARY OF THE INVENTION

The invention broadly comprises a system for modifying a prompt or a survey, including: an interface element for at least one specially programmed general-purpose computer for receiving an audio input including: a response of an employee of a first business entity to at least one prompt presented to the employee; or a response of a customer of the first business entity to at least one question presented to the customer following a transaction between the customer and the first business entity. The system also includes: a memory unit for the at least one specially programmed general-purpose computer for storing an artificial intelligence program (AIP); and a processor for the at least one specially programmed general-purpose computer for: storing the audio input in the memory unit; comparing the audio input to a first metric; modifying the at least one prompt or the at least one question using the AIP and the comparison of the audio input with the first metric; and transmitting, using the interface element, the at least one prompt or the at least one question for presentation, on a respective display device, to the employee or the customer.

In one embodiment, the processor is for generating the first metric using the AIP. In another embodiment, the first metric includes a second metric related to the employee or a third metric related to the customer and the processor is for comparing the response of the employee to the second metric, or comparing the response of the customer to the third metric. In a further embodiment, the second or third metric includes input from the first customer regarding the at least one prompt.

In one embodiment, the input from the first customer includes a response to an interaction of the first customer and the first employee resulting from the implementation of the at least one prompt, and the processor is for eliminating or modifying a prompt from the at least one prompt according to the response, or eliminating or modifying a question from the at least one question according to the response. In another embodiment, the at least one prompt includes an upsell offer and the processor is for generating or modifying the upsell offer using the AIP. In a further embodiment, the processor is for generating or modifying, using the AIP, a respective presentation for the at least one prompt, or for the at least one question.

In one embodiment, the processor is for: storing, in the memory unit historical data selected from the group consisting of: historical data regarding prompts presented to at least one employee of the first business entity; historical data regarding questions presented to at least one customer of the first business entity; historical data regarding upsell offers, the historical data including acceptance rates of previous upsell offers or financial considerations, with respect to the first business entity, of previous upsell offers; historical data regarding performance of the at least one employee with respect to the first business entity, the historical data including previous compliance of the at least one employee with respect to previously presented prompts, or financial considerations, with respect to the first business entity, of prompts previously available for presentation by the at least one employee; and data regarding a purchasing history for the at least one customer; and the processor is for generating or modifying the first metric using the processor, the AI program, and the historical data; or, the processor is for modifying the at least one prompt or the at least one question using the historical data; or, the processor is for generating the at least one prompt or the at least one question using the AI program and the historical data; or, the at least one prompt includes an upsell offer and the processor is for using the AI program and the historical data to generate or modify the upsell offer; or the processor is for generating or modifying, using the AIP and the historical data, a respective presentation for the at least one prompt, or for the at least one question.

In one embodiment, historical data regarding prompts presented to at least one employee of the first business entity includes comparison of the prompts with respect to the first metric, or wherein historical data regarding questions presented to at least one customer of the first business entity includes comparison of the questions with respect to the first metric. In another embodiment, the processor is for: receiving, using the interface element, at least one rule from a wireless communications device (WCD) or from a general-purpose computer associated with a second business entity; storing the at least one rule in the memory element; and modifying the first metric, the at least one prompt, the at least one question, or the respective presentation using the processor and the at least one rule. In a further embodiment, the first and second business entities are the same. In yet another embodiment, the respective display device for the at least one question is a WCD with a memory element and a processor and the WCD is arranged to store at least one rule in a memory element for the WCD; and execute, using the processor in the WCD, the at least one question or the respective presentation for the at least one question according to the at least one rule.

In one embodiment, the processor is for: receiving, using the interface element, at least one rule from a WCD or from a general-purpose computer associated with a second business entity; storing the at least one rule in the memory element; modifying the at least one prompt or the at least one question using the at least one rule; and transmitting, using the interface element, the modified at least one prompt or the modified at least one question for display on the respective display device. In another embodiment, the first and second business entities are the same. In a further embodiment, the respective display device for the at least one question is a WCD with a memory element and a processor and the WCD is arranged to store at least one rule in a memory element for the WCD; and execute, using a processor in the WCD, the at least one question according to the at least one rule.

The invention also broadly comprises a method for modifying a prompt or a survey.

It is a general object of the present invention to provide a system and a method to intelligently and automatically provide employee prompts and customer surveys with respect to a defined metric to optimize parameters associated with a business entity.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention system for modifying a prompt or a survey; and,

FIG. 2 is a flow chart of a present invention method for modifying a prompt or a survey.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only one of A and B.

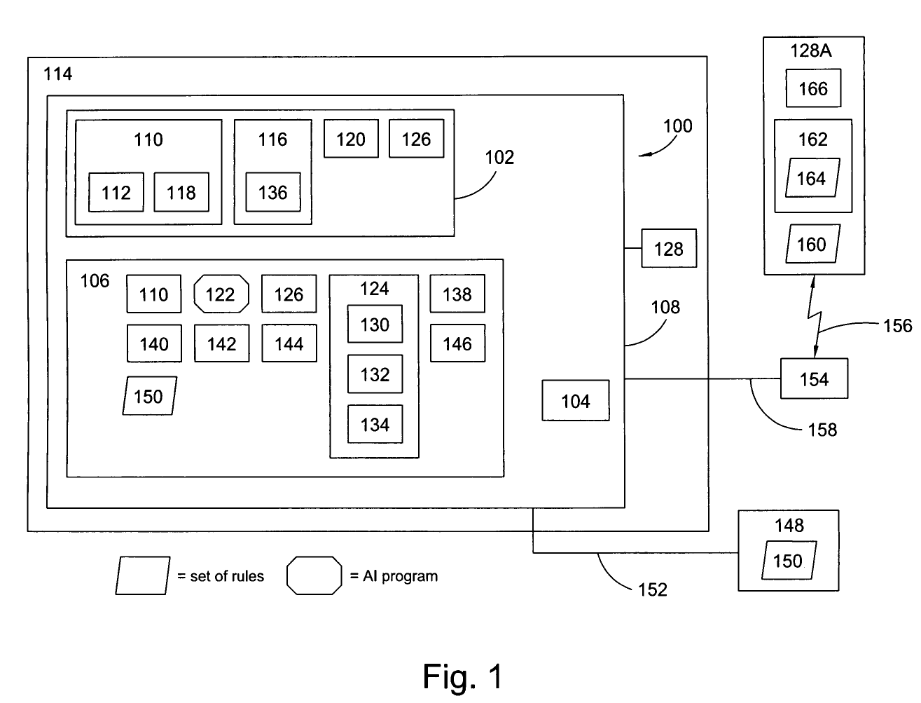

FIG. 1 is a schematic block diagram of present invention system 100 for system for modifying a prompt or a survey. The system includes processor 102, interface element 104, and memory element, or unit, 106 in at least one specially programmed computer 108. The interface element is for receiving audio input 110. In one embodiment the audio input includes response 112 of an employee (not shown) of a business entity, for example, the business entity associated with location 114, to at least one prompt, for example, prompt 116, presented to the employee. In another embodiment, the audio input includes response 118 of a customer (not shown) of the business entity to at least one question or survey, for example question 120, presented to the customer following a transaction (not shown) between the customer and the business entity. Artificial intelligence program (AIP) 122 is stored in the memory unit. The processor: stores the audio input in the memory unit; compares the audio input to metric 124 stored in the memory unit to generate comparison 126, also stored in the memory unit; modifies the prompt or the question using the AIP and comparison 126; and transmits, using the interface element, the prompt or the question for presentation, on a respective display device, for example, POS station 128 in location 114, to the employee or the customer, respectively. Thus, using the AIP and the comparison of the audio input (which represents an action of the employee or the customer) with the metric, the system is able to automatically, dynamically, and intelligently alter the prompt or the survey according to specific benchmarks (the metric), as further described infra.

By interface element, we mean any combination of hardware, firmware, or software in a computer used to enable communication or data transfer between the computer and a device, system, or network external to the computer. The interface element can connect with the device, system, or network external to the computer, using any means known in the art, including, but not limited to a hardwire connection, an optical connection, an Internet connection, or a radio frequency connection. Processor 102 and interface element 104 can be any processor or interface element, respectively, or combination thereof, known in the art.

Computer 108 can be any computer or plurality of computers known in the art. In one embodiment, the computer is located in a retail location with which system 100 is associated, for example, location 114. In another embodiment (not shown), all or parts of the computer are remote from retail locations with which system 100 is associated. In a further embodiment, computer 108 is associated with a plurality of retail locations with which system 100 is associated. Thus, the computer provides the functionality described for more than one retail location.

In one embodiment, the operations of the processor and the AIP, described supra and infra, include the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, the processor is for generating metric 124 using the AIP. In another embodiment, metric 124 includes metric 130 related to the employee or metric 132 related to the customer. The processor compares the response of the employee to metric 130, or compares the response of the customer to metric 132. Thus, metrics 130 and 132 represent more focused criteria for comparison 126, as further described infra.

In a further embodiment, metric 124 includes input 134 from the customer regarding the at least one prompt. For example, if a plurality of prompts are presented to the employee and executed by the employee as part of the transaction involving the customer, the survey could include a question as to whether the customer felt there were too many executed prompts as part of the transaction, or if any of the executed prompts were annoying or otherwise had a negative impact on the customer. If the customer's answer is positive (there were too many executed prompts or prompts were annoying), the processor can adjust the number of prompts included in prompts 116 for subsequent customer transactions. In yet another embodiment, the employee is able to input information regarding the employee's perceived response of the customer to the executed prompts and this information is used by the processor to adjust prompts for future transactions. In one embodiment the processor uses the AIP to perform the modifications to the prompts.

Display device 128 can be any display device known in the art. In one embodiment, display device is a point of sales station, for example, a cash register, at which the employee is working. In another embodiment, a customer places an order from a location remote from the location for the business entity, for example, location 114, using any means known in the art, for example, a remote kiosk (not shown) or wireless communications device (WCD) 128A. A WCD is defined supra. WCD 128A can be any WCD known in the art. Commonly-owned and co-pending U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008 is applicable to orders received from the WCD.

In one embodiment, WCD 128A is owned by, leased by, or otherwise already in possession of an end user when system 100 interfaces with the WCD. In the description that follows, it is assumed that the WCD is owned by, leased by, or otherwise already in possession of the end user when system 100 interfaces with the WCD. In general, the WCD communicates with a network, for example, network 154, via radio-frequency connection 156. Network 154 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 154 using any means known in the art, including, but not limited to a hardwire connection, an optical connection, an Internet connection, or a radio frequency connection. In the figures, a non-limiting example of a hardwire connection 158 is shown. In one embodiment, device 128A is connectable to a docking station (not shown) to further enable communication between device 128A and system 100. Any docking station or docking means known in the art can be used. That is, when the device is connected to the docking station, a link is established between the device and system 100.

In one embodiment, the system is configured to alter the survey being asked at the end of a transaction based on how the employee or customer handled the prompts made during the transaction. For example, if the customer did not respond positively to any prompts, than no survey is offered at the end of the transaction. In one embodiment the processor uses the AIP to perform the modifications to the survey.

Alternately stated, input 134 can include a response to an interaction of the customer and the employee resulting from the implementation of the at least one prompt. Then, the processor can eliminate or modify one or more prompts from the at least one prompt according to the response, or eliminate or modify one or more questions from the at least one question according to the response, for example, using the AIP.

In one embodiment, the prompt includes upsell offer 136, that is, the prompt includes one or more upsell offers to be presented to the customer by the employee. Any upsell offer known in the art can be included in the prompt. In another embodiment, the processor generates or modifies the upsell offer using the AIP. In a further embodiment, the upsell is generated as described in commonly-owned U.S. patent application Ser. No. 12/151/040: “METHOD AND SYSTEM FOR MANAGING TRANSACTIONS INITIATED VIA A WIRELESS COMMUNICATIONS DEVICE,” inventors Otto et al., filed May 2, 2008; commonly-owned U.S. patent application Ser. No. 12/151/042: “METHOD AND SYSTEM FOR GENERATING AN OFFER AND TRANSMITTING THE OFFER TO A WIRELESS COMMUNICATIONS DEVICE,” inventors Otto et al., filed May 2, 2008; commonly-owned U.S. patent application titled: “METHOD AND SYSTEM FOR GENERATING A REAL TIME OFFER OR A DEFERRED OFFER,” inventors Otto et al., filed Jul. 7, 2008; commonly-owned U.S. patent application titled: “METHOD AND APPARATUS FOR GENERATING AND TRANSMITTING AN IDEAL ORDER OFFER,” inventors Otto et al., filed Jul. 7, 2008; commonly-owned U.S. patent application titled: “SYSTEM AND METHOD FOR GENERATING AND TRANSMITTING LOCATION BASED PROMOTIONAL OFFER REMINDERS,” inventors Otto et al., filed Jul. 7, 2008; or, commonly-owned U.S. patent application titled: “SYSTEM AND METHOD FOR LOCATION BASED SUGGESTIVE SELLING,” inventors Otto et al., filed Jul. 7, 2008.

In one embodiment, the processor generates, using the AIP, a respective presentation for the prompt or the question. That is, the processor determines the format, audio/visual aspects, size, timing, or any other applicable aspect of the respective presentation. The processor can use any of the considerations, discussed infra and supra, regarding the business operation, employees, or customers to generate the respective presentations.

In one embodiment, the processor stores, in the memory unit, historical data 138 regarding prompts presented to one or more employees of the business entity. The employees can include the employee discussed supra or can include any number of other employees. That is, data 138 can be with respect to prompts in general, not just with prompts associated with the employee discussed supra. The processor uses data 138 and the AIP to generate or modify the prompt, the survey, an upsell offer included in the prompt, presentations of the prompt or survey, or metrics, such as metric 124. For example, prompts including upsells with a high rate of acceptance can be used more frequently or across a broader spectrum of transactions; for prompts including upsells with a low rate of acceptance, survey questions can be developed to ascertain the reasons for the low acceptance rate; or respective presentations can be altered to increase compliance for prompts having a low rate of compliance, for example, by reviewing presentations for prompts having higher compliance rates, ascertaining aspects of the prompts leading to the higher compliance rate, and incorporating such aspects into the prompts with lower acceptance rates.

In one embodiment, the processor stores, in the memory unit, historical data 140 regarding surveys presented to one or more customers of the business entity. The customers can include the customer discussed supra or can include any number of other customers. That is, data 140 can be with respect to surveys in general, not just with surveys associated with the customer discussed supra. The processor uses data 140 and the AIP to generate or modify the prompt, the survey, an upsell offer included in the prompt, presentations of the prompt or survey, or metrics, such as metric 124. For example, surveys with a high rate of acceptance can be used more frequently or across a broader spectrum of transactions; or respective presentations can be altered to increase compliance for surveys having a low rate of compliance, for example, by reviewing presentations for surveys having higher compliance rates, ascertaining aspects of the surveys leading to the higher compliance rate, and incorporating such aspects into the surveys with lower acceptance rates.

In one embodiment, historical data 140 includes a history of comparisons of surveys with metrics, for example, metric 124. Such a history can be used to identify trends and give a more complete overview of surveys and metrics, enabling the processor and the AIP to better generate or modify prompts, surveys, an upsell offers included in prompts, presentations of prompts or surveys, or metrics. For example, the processor can track successions, progressions, or other groupings or trends in surveys and metrics to determine and further implement more successful approaches.

In one embodiment, the processor stores, in the memory unit, historical data 142 regarding upsell offers included in prompts. The processor uses data 142 and the AIP to generate or modify the prompt, the survey, an upsell offer included in the prompt, presentations of the prompt or survey, or metric 124. The historical data can include acceptance rates of previous upsell offers, or financial considerations, with respect to the first business entity, of previous upsell offers. Financial considerations can include any of the parameters or factors described supra or infra impacting the finances of the business entity, for example, check size, net or gross profit, or inventory reduction. For example, the data regarding financial considerations, with respect to the business entity, of upsell offers previously available for presentation by the at least one employee can include, but is not limited to, check size, net or gross profit, or inventory reduction associated with upsell offers previously available for presentation by the at least one employee. In another embodiment, the financial considerations are with respect to upsells presented by the employee and accepted by customers.

In one embodiment, the memory element stores historical information 144 regarding a purchasing history for the customer. The information can include a purchasing history with respect to the business entity discussed above or with other business entities. Alternately stated, information 144 tracks customer buying habits or tracks overall customer responses with respect to entities, such as the entity associated with location 114, or tracks individual customer buying habits or tracks customer responses. The processor uses data 144 and the AIP to generate or modify the prompt, the survey, an upsell offer included in the prompt, presentations of the prompt or survey, or metric 124.

In one embodiment, historical information 144 includes information regarding searches previously performed by the customer using a wireless communications device (WCD). The processor uses the information regarding the searches and the AIP to generate or modify the prompt, the survey, an upsell offer included in the prompt, the presentation, or metric 124. For example, the information could be regarding keyword searches performed using the WCD or by an end user of the WCD. Data 144 can be used to discern patterns or other aspects regarding the use of the WCD or activities of the end users that can be useful in optimizing the prompt, the survey, an upsell offer included in the prompt, presentations of the prompt or survey, or metric 124.

In one embodiment, the processor stores, in the memory unit, historical data 146 regarding the employee and the processor uses data 146 and the AIP to generate or modify the prompt, the survey, an upsell offer included in the prompt, presentations of the prompt or survey, or metric 124. In another embodiment, data 146 includes historical information regarding performance of the employee with respect to the business entity. In a further embodiment, data 146 includes, but is not limited to: data regarding previous compliance of the employee with respect to executing, or properly responding to, previous prompts; or data regarding financial considerations, with respect to the business entity, of prompts, for example, upsell offers, previously presented to the employee. The compliance data can include, but is not limited to, a percentage of prompts actually presented by the employee with respect to a number of prompts that were available for the employee to present or the acceptance rate of prompts presented by the employee. Financial considerations can include any of the parameters or factors described supra or infra impacting the finances of the business entity, for example, check size, net or gross profit, or inventory reduction. For example, the data regarding financial considerations, with respect to the business entity, of upsell offers previously available for presentation by the at least one employee can include, but is not limited to, check size, net or gross profit, or inventory reduction associated with upsell offers previously available for presentation by the at least one employee. In another embodiment, the financial considerations are with respect to upsells presented by the employee and accepted by customers.

In one embodiment, computer 148, separate from computer 108, transmits modifying rule 150 to computer 108. Computer 148 can be in location 114 (not shown) or can be in a different location. Computer 148 can be associated with a business entity associated with location 114 or can be associated with a different business entity. Connection 152 between computers 108 and 148 is any type known in the art. In another embodiment (not shown), multiple computers 148 are included and respective computers among the multiple computers can be associated with the same or different business entities. Computer 108 stores modifying rule 150 in the memory unit. The processor generates or modifies the prompt, the survey, an upsell offer included in the prompt, presentations of the prompt or survey, or metric 124 using rule 150. Computer 148 generates rule 150, and the processor modifies the prompt, the survey, an upsell offer included in the prompt, presentations of the prompt or survey, or metric 124 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 108 receives at least one modifying rule 160 from a WCD and stores the rule in the memory unit. In another embodiment, the WCD is WCD 128A. The processor generates or modifies the prompt, the survey, an upsell offer included in the prompt, presentations of the prompt or survey, or metric 124 using rule 160. The WCD generates rule 160, and the processor modifies the prompt, presentations of the prompt or survey, or metric 124 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008.

In one embodiment, the respective display device for the at least one question is a WCD, for example, WCD 128A. For example, the customer has initiated or is carrying out the transaction using a WCD. Memory element 162 in WCD 128A stores at least one rule 164 and processor 166 in the WCD implements the survey according to rule 164. The WCD generates rule 164, and operates on the survey as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008.

In one embodiment, employees are grouped according to similarities in performance or results regarding prompts or surveys, for example, using data 146. The system generates or modifies prompts or surveys for use with the grouped employees. In another embodiment, customers are grouped according to similarities regarding prompts or surveys presented during transactions involving the customers, for example, using data 144. The system generates or modifies prompts or surveys for use with the grouped customers.

The following is a non-limiting list of ways in which a prompt can be modified. It should be understood that modification of a prompt by the present invention is not limited to these examples:
1. The wording of the prompt can be altered if the employee is not enunciating the prompt in a way that results in an acceptance customer response, for example, a specified acceptance rate for an item in an upsell being offered with the prompt.
2. Whether or not to offer the prompt, which can be altered by the employee, administrator, or automatically by the processor, according to any metric, for example, if the prompt does not yield incremental revenue or profit.
3. When to offer the prompt, which can be altered based on any metric, for example, how successful the employee is in getting the customer to react to the prompt at any given point in a transaction flow.
4. Whether or not to enforce the speaking of the prompt, which can be altered based on any metric, for example, how long it takes an employee to speak the prompt and or process a transaction. In this embodiment, the system can decide whether or not to allow the transaction to continue if a prompt is or is not spoken or is spoken with sufficient clarity.
5. How long to allow the employee to say the prompt, which can be altered based on any metric, for example, how quickly an employee is able to speak a prompt.
6. How many prompts can be inserted in a given transaction, which can be altered based on any metric, for example, a success metric associated with the transaction, for example, how successful executed prompts are in optimizing the average check.
7. Where the prompt is offered (i.e. what hardware device) can be altered to optimize acceptance of or response to prompts.

The following is a non-limiting list of ways in which a survey, or question, can be modified. It should be understood that modification of a survey, or question, by the present invention is not limited to these examples:
1. The frequency of presenting survey can be modified based on responses to the surveys, for example, surveys that receive a negative response can be offered more often, or surveys that receive a positive response can be offered less often.
2. Surveys that do not receive a response can be eliminated or altered until the surveys achieve a specified level of response.
3. How a survey is worded can be altered to illicit a desired response, for example: a reaction; a negative response; or a positive response.
4. The number of surveys presented during or after a given transaction or group of transactions can be altered to maximize survey responses or any other metric, for example, transaction throughput.

The following is a non-limiting list of metric 130, it should be understood that metric 130 is not limited to these examples:
1. Employee clarity in speaking prompt.
2. Rate for desired responses by customer in response to prompts.
3. Time needed to execute a prompt.
4. The number of prompts that can be spoken within a given time

The following is a non-limiting list of metric 132, it should be understood that metric 132 is not limited to these examples:
1. Any response to a prompt.
2. A positive response to a prompt.
3. A negative response to a prompt.

The following is a non-limiting list of factors system 100 can use to generate or modify prompts, it should be understood that such factors are not limited to these examples:
1. Temporal factors, such as the time of day, week, month, or year.
2. The employee involved, for example, using data 146.
3. The nature of the transaction, for example, determining feasible upsells to include in a prompt.
4. The customer involved, for example, using data 144.
5. The location at which the transaction is occurring.
6. The hardware type being used to execute the transaction.
7. The history of prompts or surveys, for example, using data 138, 140, or 142. The history can include desired responses elicited by surveys or lack of desired responses elicited by surveys.

In general, the use of rules or AIP 122 (and any other rules or artificial intelligence programs discussed infra) is directed to generating or modifying prompts, surveys, presentations of prompts or surveys, upsells included in prompts, and metrics used to evaluate the effectiveness of the preceding while optimizing the attainment of one or more goals established by a business entity owning a business using the system, for example, a business entity owning location 114, or optimizing one or more parameters associated with operations of the business entity. For example, generating or modifying prompts, surveys, presentations of prompts or surveys, upsells included in prompts, or metrics, or performing the other operations described herein associated with rules or artificial intelligence programs, includes making a selection of one or more choices from among two or more choices that yields the best or optimized outcome or yields. Optimization or maximization can be with respect to revenues, profits, item counts, average check, market basket contents, marketing offer acceptance, store visitation or other frequency measures, or improving or optimizing speed of service inventory levels, turns, yield, waste, enhancing or optimizing customer loyalty or use of kiosks or internet or other POS devices or self service devices, use of coupons or acceptance of marketing offers, reduction or optimization of any customer or cashier or any other person's gaming, fishing, or any other undesirable action or activities or failures to act when desired, minimizing or optimizing any dilution or diversion of sales, profits, average check, minimizing or optimizing use of discounts and other promotions so as to maximize or optimize any of the foregoing desired actions, outcomes or other desired benefits, or any combination of minimizing undesired results while maximizing or optimizing any one or more of any desired results.

In one embodiment, any means known in the art, for example, as described in commonly-owned U.S. patent application titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008 is used to identify a WCD, for example, WCD 128A.

It should be understood that system 100 can be operated by the same business entity operating or owning a business location using the system, or can be operated by a third party different than the business entity operating or owning the business location using the system. In one embodiment, a third party operates system 100 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 100 can be integral with a computer operating system for a business location, for example, location 114 or with a business entity operating the business location. It also should be understood that system 100 can be wholly or partly separate from the computer operating system for a retail location, for example, location 114, or with a business entity operating the business location.

It should be understood that although individual rule sets and a single artificial intelligence program are discussed, the individual rule sets can be combined into a composite rules set (not shown). Further, the functions described for AIP 122 can be implemented by combinations of separate AIPs (not shown). Any combination of individual rule sets or artificial intelligence programs is included in the spirit and scope of the claimed invention.

In general, system 100, and in particular, the processor using the AI program, operates to use artificial intelligence, for example, a generic algorithm to inform or make the decisions discussed in the descriptions for FIG. 1. In one embodiment, system 100 uses one or all of the historical data noted supra, to generate or modify prompts, surveys, presentations of prompts or surveys, upsells included in prompts, or metrics, or performing the other operations described herein to attain or maximize an objective of the business entity. Factors usable to determine an objective can include, but are not limited to: customer acceptance rate, profit margin percentage, customer satisfaction information, service times, average check, inventory turnover, labor costs, sales data, gross margin percentage, sales per hour, cash over and short, inventory waste, historical customer buying habits, customer provided information, customer loyalty program data, weather data, store location data, store equipment package, POS system brand, hardware type and software version, employee data, sales mix data, market basket data, or trend data for at least one of these variables.

The discussion of the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to the generation or modification of prompts, surveys, presentations of prompts or surveys, upsells included in prompts, or metrics, or performing the other operations described herein with respect to the AIP.

It should be understood that various storage and removal operations, not explicitly described above, involving memory unit 106 and as known in the art, are possible with respect to the operation of system 100. For example, outputs from and inputs to the general-purpose computer can be stored and retrieved from the memory elements and data generated by the processor can be stored in and retrieved from the memory.

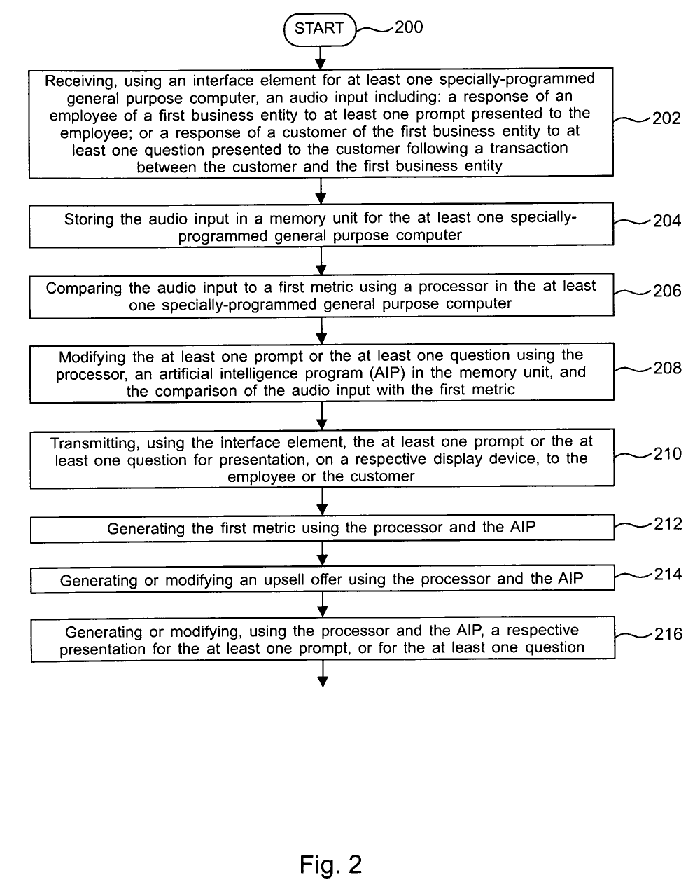

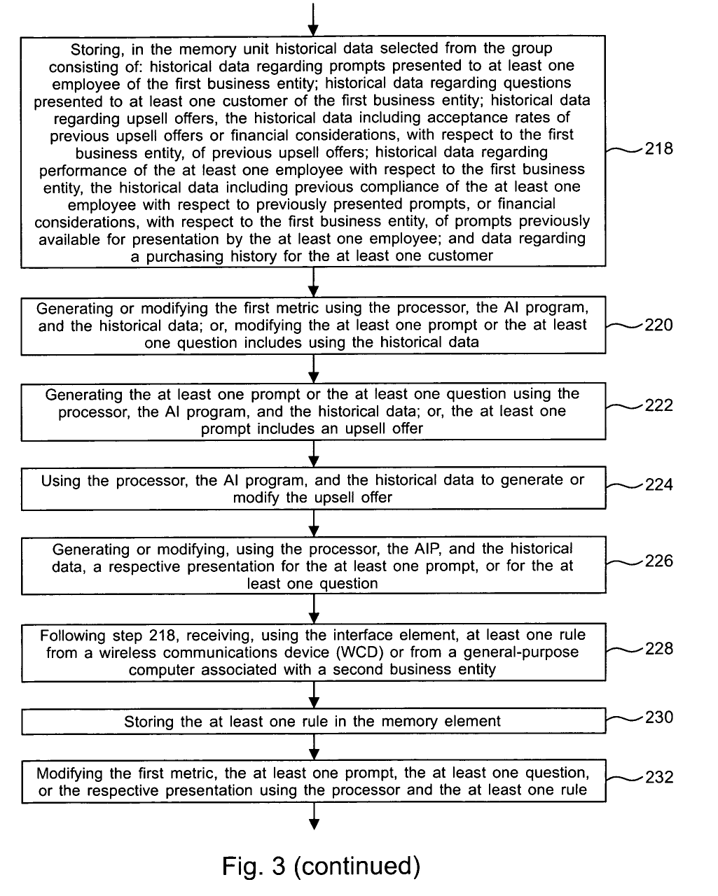

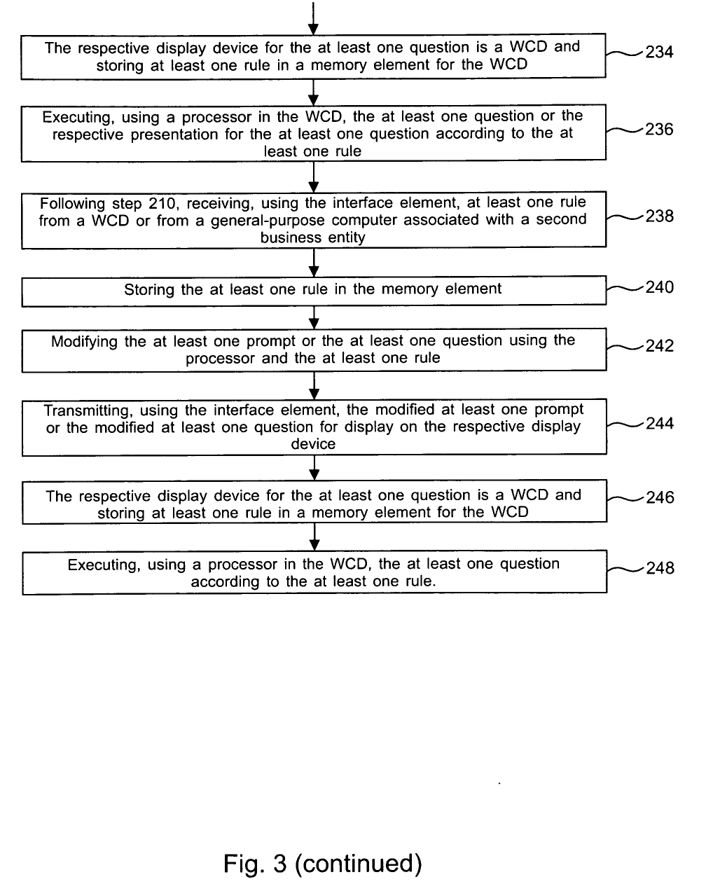

FIG. 2 is a flow chart illustrating a present invention computer-based method for modifying a prompt or a survey. Although the method in FIG. 2 is depicted as a sequence of numbered steps for clarity, no order should be inferred from the numbering unless explicitly stated. The method starts at Step 200. Step 202 receives, using an interface element for at least one specially-programmed general purpose computer, an audio input including: a response of an employee of a first business entity to at least one prompt presented to the employee; or a response of a customer of the first business entity to at least one question presented to the customer following a transaction between the customer and the first business entity. Step 204 stores the audio input in a memory unit for the at least one specially-programmed general purpose computer; step 206 compares the audio input to a first metric using a processor in the at least one specially-programmed general purpose computer; step 208 modifies the at least one prompt or the at least one question using the processor, an artificial intelligence program (AIP) in the memory unit, and the comparison of the audio input with the first metric; and step 210 transmits, using the interface element, the at least one prompt or the at least one question for presentation, on a respective display device, to the employee or the customer.

In one embodiment, step 212 generates the first metric using the processor and the AIP. In another embodiment, the first metric includes a second metric related to the employee or a third metric related to the customer and comparing the audio input includes comparing the response of the employee to the second metric, or comparing the response of the customer to the third metric. In a further embodiment, the second or third metric includes input from the first customer regarding the at least one prompt.

In one embodiment, the input from the first customer includes a response to an interaction of the first customer and the first employee resulting from the implementation of the at least one prompt, and modifying the at least one prompt includes eliminating or modifying a prompt from the at least one prompt according to the response, or modifying the at least one question includes eliminating or modifying a question from the at least one question according to the response. In another embodiment, the at least one prompt includes an upsell offer and step 214 generates or modifies the upsell offer using the processor and the AIP. In a further embodiment, step 216 generates or modifies, using the processor and the AIP, a respective presentation for the at least one prompt, or for the at least one question.

In one embodiment, step 218 stores, in the memory unit historical data selected from the group consisting of: historical data regarding prompts presented to at least one employee of the first business entity; historical data regarding questions presented to at least one customer of the first business entity; historical data regarding upsell offers, the historical data including acceptance rates of previous upsell offers or financial considerations, with respect to the first business entity, of previous upsell offers; historical data regarding performance of the at least one employee with respect to the first business entity, the historical data including previous compliance of the at least one employee with respect to previously presented prompts, or financial considerations, with respect to the first business entity, of prompts previously available for presentation by the at least one employee; and data regarding a purchasing history for the at least one customer; and step 220 generates or modifies the first metric using the processor, the AI program, and the historical data; or, modifying the at least one prompt or the at least one question includes using the historical data; or, step 222 generates the at least one prompt or the at least one question using the processor, the AI program, and the historical data; or, the at least one prompt includes an upsell offer and step 224 uses the processor, the AI program, and the historical data to generate or modify the upsell offer; or, step 226 generates or modifies, using the processor, the AIP, and the historical data, a respective presentation for the at least one prompt, or for the at least one question.

In one embodiment, the historical data regarding prompts presented to at least one employee of the first business entity includes comparison of the prompts with respect to the first metric, or historical data regarding questions presented to at least one customer of the first business entity includes comparison of the questions with respect to the first metric. In another embodiment, following step 218, step 228 receives, using the interface element, at least one rule from a wireless communications device (WCD) or from a general-purpose computer associated with a second business entity; step 230 stores the at least one rule in the memory element; and step 232 modifies the first metric, the at least one prompt, the at least one question, or the respective presentation using the processor and the at least one rule. In a further embodiment, the first and second business entities are the same.

In one embodiment, the respective display device for the at least one question is a WCD and step 234 stores at least one rule in a memory element for the WCD; and step 236 executes, using a processor in the WCD, the at least one question or the respective presentation for the at least one question according to the at least one rule. In another embodiment, following step 210, step 238 receives, using the interface element, at least one rule from a WCD or from a general-purpose computer associated with a second business entity; step 240 stores the at least one rule in the memory element; step 242 modifies the at least one prompt or the at least one question using the processor and the at least one rule; and step 244 transmits, using the interface element, the modified at least one prompt or the modified at least one question for display on the respective display device. In a further embodiment, the first and second business entities are the same. In yet another embodiment, the respective display device for the at least one question is a WCD and step 246 stores at least one rule in a memory element for the WCD; and step 248 executes, using a processor in the WCD, the at least one question according to the at least one rule.

The following is a present invention method:
1. Survey/Prompt Offer:
   a. Receive transaction information.
   b. Determine appropriate survey or prompt pool using rules or AIP.
   c. Score surveys and prompts in pool.
   d. Output surveys and prompts offer(s) based on rules or AIP, and score.
   e. Receive a response to the prompt.
   f. Store prompt response.
2. Survey and Prompt Alteration:
   a. Retrieve prompt response.
   b. Compare prompt responses.
   c. Alter prompt, for example, offer included in prompt, based on response comparison.
   d. Store altered surveys.

The following should be viewed in light of FIGS. 1 and 2. In one embodiment, for any or all of those instances of a present invention system or method in which an artificial intelligence program or generic algorithm is used, a rule or set of rules (not shown) is used in conjunction with the artificial intelligence program or generic algorithm. For example, in the preceding embodiment, the processor uses data 144, the AIP, and a rule or set of rules (not shown) stored in the memory element to generate or modify the prompt, the survey, an upsell offer included in the prompt, presentations of the prompt or survey, or metric 124. The operation of an artificial intelligence program or generic algorithm with a rule or set of rules is described in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

Although the discussion infra is with respect to a present invention system, it should be understood that the discussion also is applicable to a present invention method. In one embodiment of a present invention system, the use of table-based, rules-based, or artificial intelligence-based processing, as described in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is for the functions ascribed to the AIP.

In one embodiment, commonly-owned U.S. patent application, labeled: “METHOD AND SYSTEM FOR PROVIDING AN EMPLOYEE AWARD USING A GENETIC ALGORITHM,” inventors Otto et al., filed concurrently and incorporated by reference herein, is applicable to the generation, modification, or presentation of an employee prompt, for example, prompt 116. For example, the prompt is at least partly generated, modified, or presented as described in the above application.

The present invention leverages existing or future marketing systems, marketing programs, loyalty programs, sponsor programs, coupon programs, discount systems, incentive programs, or other loyalty, marketing, or other similar systems, collectively, “marketing systems” by adding programming logic, self-learning, and self-adaptation to generate or modify metrics, prompts, offers, or surveys; and to determine when or how to present the prompts, offers, or surveys. The present invention can use any, all, or none of the following considerations as part of generating or modifying metrics, prompts, offers, or surveys; and determining when or how to present the prompts, offers, or surveys, for example, by adding programming logic, self-learning, and self-adaptation as noted supra:
1. One or more business, customer or sponsor objectives.
2. Location of a device used to enter a transaction or location or device that receives or displays a marketing message or offer or that is otherwise controlled or affected by one or more marketing systems, including, for example, at a point of sale (POS) Terminal, WCD, Internet Enabled Device, Cell Phone, Kiosk, Laptop or PC, or any other device, or a location, e.g., at a retail outlet, quick service restaurant, drive through, front counter, kiosk station, table, at home, on the road, passing by, walking by, driving by, walking or driving near to, entering or leaving a location, or any other device or location information available to any such marketing system(s).
3. Temporal parameters, such as, time of day, day of week, month, or year.
4. Any one or more data or variables available or accessible, including, for example, any customer, business or sponsor information, such as, membership in a loyalty or other marketing program, ordering preferences or history, current sales volumes or budgets or targets, current or planned local, regional or national marketing programs or objectives, device preferences, for example, use of a kiosk in preference to a front counter or other device, current speed of service, quality of service or other operating data, budgets, objectives or trends, etc.

In one embodiment, the present invention employs any, all, or none of the following considerations as part of discriminating, for example, by adding programming logic, self-learning, and self-adaptation as noted supra:
1. Location
2. Transaction Entry Device
3. Customer Information or objectives
4. Business Information or objectives
5. Sponsor Information or objectives
6. Marketing Program Type
7. Opt In Information
8. Offer Type
9. Payment method or terms or conditions of payment
10. Marketing Message Contents
11. Marketing Offer Objectives
12. Expected or Actual System Results or tracking data
13. System determined discounts or other incentives required to achieve desired results
14. One or more table entries provided by one or more end users, for example, a system administrator
15. One or more rules provided by one or more end users, for example, a system administrator
16. One or more genetic algorithms or other AI based rules or determination methods
17. Any other information, data, rules, system settings, or otherwise available to the marketing system or disclosed invention or the POS system or other system designed to deliver one or more marketing messages, offers, or coupons, etc.
18. Any combination or priority ranking of any two or more of the foregoing

In another embodiment, in an effort to further enhance generating or modifying metrics, prompts, offers, or surveys; or determining when or how to present the prompts, offers, or surveys, or to otherwise improve one or more aspects of the present invention, the invention may access certain information from existing systems, including, for example, existing POS databases, such as customer transaction data, price lists, inventory information or other in or above store, for example, location data, including, but not limited to data in a POS, back office system, inventory system, revenue management system, loyalty or marketing program databases, labor management or scheduling systems, time clock data, production or other management systems, for example, kitchen production or manufacturing systems, advertising creation or tracking databases, including click through data, impressions information, results data, corporate or store or location financial information, including, for example, profit and loss information, inventory data, performance metrics, for example, speed of service data, customer survey information, digital signage information or data, or any other available information or data, or system settings data. In one embodiment, one or more of the above operations are performed using the AIP.

In one embodiment, each location associated with the present invention establishes its own rules, uses its own AIP or generic algorithm, or learns from local employee or customer behavior or other available information. In another embodiment, the present invention shares some or all available information or results data among any two or more or all locations or locations that fall within a given area, region, geography, type, or other factors, such as menu pricing, customer demographics, etc., and makes use of such information to improve the present invention's ability to generate or modify metrics, prompts, offers, or surveys; or to determine when or how to present the prompts, offers, or surveys. For example, when using an AI based system, such as disclosed in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007,” one location may discover or otherwise determine that a certain type or class of prompt or survey is particularly effective. By sharing such information among other locations, for example, similar locations, the present invention can begin to make use of the same or similar prompts or surveys in other generally similar locations or with other similar employees, types of employees, customers, or classifications of customers so as to improve the performance of one or more other such locations or all locations. In this fashion, the present invention can learn which metrics, prompts, offers, surveys, or presentations more quickly or generally achieve the desired results or improve trends towards such results. Likewise, the present invention can more quickly determine which metrics, prompts, offers, surveys, or presentations do not yield the desired results or determine how long such metrics, prompts, offers, surveys, or presentations are required to achieve the desired results.

In a further embodiment, incentives are provided or subsidized by one or more third parties, including, for example, third party sponsors. For example, a vendor supplying an item in an upsell offer could subsidize the upsell offer to encourage acceptance of the item. In another example, such an offer may be partially or fully subsidized by an unrelated third party sponsor. For example, as part of an upsell, a telecommunications company offers to view an advertisement for telecommunications company or fill out a survey or perform some other action or accept a subsequent or related optional or required offer, etc. In one embodiment, one or more of the above operations are performed using the AIP.

The following U.S. patent applications are applicable to an upsell offer: U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application Ser. No. 12/151/043, titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008; commonly-owned U.S. patent application Ser. No. 12/151,038, titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008; commonly-owned U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008; commonly-owned U.S. patent application No. 12/151,042, entitled “METHOD AND SYSTEM FOR GENERATING AN OFFER AND TRANSMITTING THE OFFER TO A WIRELESS COMMUNICATIONS DEVICE”, filed May 2, 2008; commonly-owned U.S. patent application Ser. No. 12/151,042, entitled “METHOD AND SYSTEM FOR GENERATING AN OFFER AND TRANSMITTING THE OFFER TO A WIRELESS COMMUNICATIONS DEVICE”, filed May 2, 2008; commonly-owned U.S. patent application entitled “SYSTEM AND METHOD FOR PROVIDING INCENTIVES TO AN END USER FOR REFERRING ANOTHER END USER”, inventors Otto et al., filed Jul. 9, 2008; commonly-owned U.S. patent application entitled “METHOD AND SYSTEM FOR GENERATING A REAL TIME OFFER OR A DEFERRED OFFER”, inventors Otto et al., filed Jul. 9, 2008; commonly-owned U.S. patent application entitled “METHOD AND APPARATUS FOR GENERATING AND TRANSMITTING AN IDEAL ORDER OFFER”, inventors Otto et al., filed Jul. 9, 2008; commonly-owned U.S. patent application entitled “SYSTEM AND METHOD FOR GENERATING AND TRANSMITTING LOCATION BASED PROMOTIONAL OFFER REMINDERS”, inventors Otto et al., filed Jul. 9, 2008; commonly-owned U.S. patent application entitled “SYSTEM AND METHOD FOR LOCATION BASED SUGGESTIVE SELLING”, filed Jul. 9, 2008; and commonly-owned U.S. patent application entitled “SYSTEM AND METHOD FOR SCANNING A COUPON TO INITIATE AN ORDER”, filed May 2, 2008.

In another embodiment, the present invention generates or modifies metrics, prompts, offers, or surveys; or determines when or how to present the prompts, offers, or surveys based upon other performance data or results. In a further embodiment, the present invention determines the impact of metrics, prompts, upsells, surveys, or presentations on the ability or proclivity of an employee or customer to game or fish the present invention. The system avoids or ceases metrics, prompts, upsells, surveys, or presentations and/or changes the type of metrics, prompts, upsells, surveys, or presentations provided or suppressed. In one embodiment, one or more of the above operations are performed using the AIP.

In one embodiment, metrics, prompts, upsells, surveys, or presentations vary from employee to employee, from customer to customer, or from time to time, and/or one or more of these may be consistent regardless of the employee, customer, or time or other information. In a another embodiment, where metrics, prompts, upsells, surveys, or presentations vary, such metrics, prompts, upsells, surveys, or presentations are determined via any applicable means and using any available information to make such determination, including, for example, any available customer, business or sponsor information and/or any one or more customer, business or sponsor objectives and/or any combination of the forgoing. In a further embodiment, metrics, prompts, upsells, surveys, or presentations are further determined or modified based upon information or needs or business objectives of one or more suppliers and/or competitors of such suppliers. For example, if a WCD is within a geographical area for a location selling competing items A and B, a prompt is sent regarding offers for one or both of the items an vendors for the items underwrite the cost for the offer to the business entity. In one embodiment, one or more of the above operations are performed using the AIP.

In one embodiment, a present invention system generates or modifies metrics, prompts, offers, or surveys; or to determine when or how to present the prompts, offers, or surveys based upon current or previous buying habits or any other available information regarding a customer. If for example, an end user is a loyal customer for item A, the present invention may not include item A in an upsell and/or include a different item in an upsell depending upon any known factors, for example, did the customer receive or act upon an offer for item B. If the customer did receive or act upon a reminder for item B, in another embodiment, the present invention includes in an offer regarding item A, blandishments to purchase item A instead of item B, and/or provide incentives matching or exceeding incentives in a reminder for item B, and/or query such loyal (or other) customer to determine what such customer would require in a reminder for item A to respond to the offer. In this fashion a competitive environment is created. In a further embodiment, the end user of a present invention system modifies the rules or method of operation so as to favor itself. For example, in the previous example, if the producer of item A were the sole end user of the present invention, the producer may choose to not share any part or all of any such customer information or may use knowledge of any reminder regarding item B to its benefit. In another example, if a grocery chain was the sole end user of the present invention, the end user may choose to provide equal access to the present invention or favor one or more of its suppliers based upon any one or more of its business objectives, for example, the profitability and/or perceived or actual quality or consistency or pricing of such one or more suppliers. In one embodiment, one or more of the above operations are performed using the AIP.

In another embodiment of the present invention, past buying information is used to generate or modify metrics, prompts, offers, or surveys; or to determine when or how to present the prompts, offers, or surveys. For example, if a retail chain knows that one or more customers in its stores have previously purchased a High Definition Television (TV) set, and the customer is identified during a transaction, the disclosed system determines that an upsell regarding related products should be generated and transmitted. In a further embodiment, the reminder includes specific reference to the customer or the customer's purchase of the TV set. In one embodiment, one or more of the above operations are performed using the AIP.

In one embodiment, the present invention determines a location of customer placing an order remotely, for example, using a WCD. Such determination may be made using any applicable means, including, for example, using a method of triangulation of a given WCD, such as a cell phone or PDA device. Methods to locate, within a given distance a given cell phone or other cellular device, for example, a PDA equipped with cellular communications abilities, are well known by those of ordinary skill in the art and in the prior art. By considering a customer or prospective customer's current location or by estimating a destination or route of travel, a marketing system can better determine how to generate or modify metrics, prompts, offers, or surveys; or how to determine when or how to present the prompts, offers, or surveys. In one embodiment, one or more of the above operations are performed using the AIP.

In one embodiment, a customer's previous buying habits are used to generate or modify metrics, prompts, offers, or surveys; or to determine when or how to present the prompts, offers, or surveys. For example, if a loyal quick service restaurant chain customer regularly visits this or other restaurants for lunch, but rarely, if ever, visits this or other quick service restaurant locations for dinner, the present invention can offer an upsell for a free or discounted item or meal if such customer visits now or at some future date during certain hours, for example, 5 pm to 11 pm. In one embodiment, one or more of the above operations are performed using the AIP.

In another embodiment, in order to receive or otherwise qualify to receive such targeted marketing messages or offers remotely, customers, that is, existing or prospective customers are required to opt in to a cellular marketing program or some other loyalty program indicating their desire or providing permission for such marketing system or company to send one or more such marketing offers or messages. In this fashion, only those interested in such communications will be sent such communications.

In a further embodiment, such customers or prospective customers indicate through the surveys the type of offers or the frequency of offers or the value of such offers, for example, amount or type of discount, etc., that they wish the present invention to consider before presenting a prompt regarding any one or more such offers. For example, a cell phone subscriber can opt in to a cellular marketing network, indicating a general willingness to accept offers related to prompts, but then restrict the present invention from making certain offers or offer types or within certain categories, for example, such cell phone subscriber may be willing to accept discount offers from specific business entities but not from any others, or may accept from other retailers, but only when or if such other retailer's provide a discount greater than 20% off the usual price for the offered item or items. Using an interface to permit designation of such preferences, end users, for example, existing or prospective customers can provide the present invention with additional customer information that can help the present invention determine how to generate or modify metrics, prompts, offers, or surveys; and how to determine when or how to present the prompts, offers, or surveys. In one embodiment, one or more of the above operations are performed using the AIP.

In one embodiment, customers identify themselves using overt actions, for example, by swiping a card, in other embodiments, in addition or in the alternative to providing such identification means overtly, such end users may identify themselves passively, including, for example, by providing a cell phone number, GPS identification number or IP address, or a license plate number. In another embodiment, the present invention uses such identification means to retrieve information about an end user, for example, customer, business or sponsor information, which information may be further used to better or optimally determine how to generate or modify metrics, prompts, offers, or surveys; or how to determine when or how to present the prompts, offers, or surveys.

In a further embodiment, offers, upsells, or surveys are presented to prospective customers having an identity previously provided by an existing customer, as described in commonly-owned U.S. patent application titled: “SYSTEM AND METHOD FOR PROVIDING INCENTIVES TO AN END USER FOR REFERRING ANOTHER END USER,” inventors Otto et al., filed concurrently, which application is incorporated by reference herein. For example, if an existing quick service restaurant chain customer provides one or more prospective customer's identity, when such prospective customer is identified during a transaction at a quick service restaurant chain's participating locations, the present invention generates or modifies metrics, prompts, offers, or surveys; or determines when or how to present the prompts, offers, or surveys geared to potential customers from the program and provides the identity of the referring party along with such message or offer. In one embodiment, one or more of the above operations are performed using the AIP.

In another embodiment, metrics, prompts, offers, surveys, or presentations vary from customer to customer or from time to time, or in whole or in part are consistent regardless of the customer, or time or other information. In cases where metrics, prompts, offers, surveys, or presentations vary, such metrics, prompts, offers, surveys, or presentations can be determined via any applicable means and using any available information to make such determination, including, for example, any available customer, business or sponsor information or any one or more customer, business or sponsor objectives or any combination of the forgoing. Such offers or messages can be further determined or modified based upon information or needs or business objectives of one or more suppliers or competitors of such suppliers. For example, if while walking through the isles of a grocery store, a customer comes upon an “end cap” or an area designed to promote one or more items or brands, and such customer receives an offer to purchase, for example, buy two, two liter bottles of a beverage for the price of one. Such customer may accept such message or may receive an additional message, for example, buy two, two liter bottles of a competitor's beverage and get both for the price of one, plus one additional six pack of small cans of the competitor's beverage. In this fashion, product providers or producers or retailers or distributors may provide one or more incentives to purchase one or more products, which offers may or may not be influenced by or competitive with any other such offers. In one embodiment, one or more of the above operations are performed using the AIP.

In a further embodiment, metrics, prompts, offers, surveys, or presentations, are created or maintained centrally or in a distributed network, including, for example, locally. Such management may be accomplished via any applicable means available, including, for example, making use of existing, for example, off the shelf and/or customized tools that provide for such creating, management or distribution.

In one embodiment, the present invention improves results over time or with use of the invention. Such improvement or optimization can be accomplished via any means necessary including any of several methods well known in the art or as disclosed by applicants and incorporated herein by reference, including, for example, commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008; and commonly-owned U.S. patent application titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008. For example, statistical methods can be used to determine which metrics, prompts, offers, surveys, or presentations generally yield the desired or optimal or generally better results, or such results may be determined using one or more genetic algorithms, or a present invention administrator/operator can review results reports and then provide manual weighting criteria to further define or control the present invention, or a combination of these and other well known methods may be employed in any combination or in any order or priority.

In a further embodiment, a present invention upsell in a prompt includes a discount. Such discounts can be associated or applied to specific items within the offer, or to the entire offer contents. In one embodiment, discounts are determined based upon rules established by management of the present invention or as established or modified from time to time by any authorized personnel, or may be initially established or modified using a learning system, e.g., a genetic algorithm. In any such case, the present invention can make use of any or all available information, including, but not limited to customer information. Discounts can be designed to maximize, minimize or optimize any one or more business or customer objectives as desired or indicated. In another embodiment, the discount, if any, is presented to the customer as a percentage discount or as a cents or other amount off discount.

In one embodiment, discounts in incentives are used/tried relatively sparingly to determine the price elasticity of customers, both as a whole and/or by class, group, demographics, type or order contents, base order amounts, and/or specific customer's buying habits and acceptance/rejection information. In this fashion, the present invention can, over time, yield optimal results by learning or otherwise determining what incentives, if any, are required given the known information. For example, if customer A never orders item 1 with item 2, the present invention could include in the upsell offer a 10% discount to combine items 1 and 2 in an order. If the customer rejects such offer, the present invention could attempt the same or similar upsell offer upon the next customer's order entry, but this time offer a larger discount, for a 20% discount. Once the present invention determines a customer's price point, and/or the customer becomes habituated to ordering the item or service in the offer, the present invention can reduce or eliminate related discounts or other incentives. In one embodiment, one or more of the above operations are performed using the AIP.

In another embodiment, the present invention, having acquired data regarding customer price elasticity and other information, uses such information to determine other offers for the same or generally similar customers, e.g., other customers who purchase item 1 but do not typically purchase item 2. In a further embodiment, using such logic, the present invention determines classifications of customers and leverage use of such information by providing ideal order offers that are also optimized from the location or location management perspective/objectives. In one embodiment, one or more of the above operations are performed using the AIP.

In a further embodiment, an administrator can add or change or otherwise modify the previous listing, or data, or determine the order of priority or preference of each such discrimination factors or preferences or data, including, for example, location, payment or device, ranking each in order of such preference or providing table, rules or other entries to provide or assist or to support determining which are preferred or the amount of incentive available or increased or decreased incentive, as a percentage or absolute or relative or other dollar or other calculation method to determine what offers, if any to make, at which locations, devices or payment methods or other discriminating factors, for example, customer or business preferences or customer, business, sponsor or other entity information, objectives, rules or other available information or rules or system settings. By providing or otherwise manually or automatically determining such rankings, the disclosed invention can initially or continuously evaluate potential marketing offers or messages and modify or deliver such marketing messages or offers or provide other incentives to drive a desired percentage of business or customer transactions to one or more particular devices, locations or payment methods. In one embodiment, one or more of the above operations are performed using the AIP.

In one embodiment, the present invention provides such incentives initially, or on an ongoing basis or only until certain objectives are achieved or certain customers or all customers are generally habituated to making use of such certain devices, locations or payment methods, after which, in certain embodiments, the present invention may cease, temporarily or permanently making such offers based upon such discriminating factors, or may reduce the difference in incentives, or may only periodically provide such full discounts or reduced discounts so as to reinforce such behavior. In another embodiment, a system administrator or other end user establishes such rules or conditions. In one embodiment, one or more of the above operations are performed using the AIP.

In a further embodiment, the present invention makes such determinations using an automated means. Such automated means includes, for example, a system that periodically or generally continuously tests different metrics, prompts, offers, surveys, or presentations or other methods, for example, user interfaces, or other benefits or incentives, and based upon such testing, determine which metrics, prompts, offers, surveys, or presentations or other benefits yield the desired results or frequency of use of any such locations, devices or payment methods. Such automated system may periodically cease making such metrics, prompts, offers, surveys, or presentations or providing the same or similar metrics, prompts, offers, surveys, or presentations or other benefits once it is determined that the desired customer behavior has been established, habituated or otherwise persists without need for such continued metrics, prompts, offers, surveys, or presentations or benefits. If such system subsequently determines that the desired behavior has ceased or fallen below a desired level, such system can then reinstate such metrics, prompts, offers, surveys, or presentations or benefits. When reinstating such metrics, prompts, offers, surveys, or presentations or benefits, the present invention can return to previously successful levels or can provide different metrics, prompts, offers, surveys, or presentations, on a temporary, periodic or permanent basis. Such reinstatement may be provided for all customers, certain customers, classes of customers, or only those customers that have ceased or have generally reduced their frequency of desired behavior or use of generally more desirable devices, locations or payment methods.

In a further embodiment, the present invention tests metrics, prompts, offers, surveys, or presentations or providing certain benefits on a periodic basis within a single location or among a plurality of locations so as to determine the extent or requirement regarding any such metrics, prompts, offers, surveys, or presentations or other benefits. For example, by testing making offers and not making offers, the present invention can determine if any such offers are required at all to drive business transactions to a kiosk or such a system can further determine the extent of any gaming, dilution, diversion or accretion. By alternating making and not making offers or by testing various levels of incentives or discounts, the present invention can better determine the optimal incentive, discount or benefits required, if any, to achieve the desired results, while minimizing or mitigating any undesirable effects of using or deploying such system. Such testing can be accomplished via any applicable or available means, including those previously disclosed by applicants herein and within the referenced applications, or randomly or using rules or AI based systems. By periodically testing or making changes to such metrics, prompts, offers, surveys, or presentations or benefits, the present invention can continually strive to achieve the optimal mix and level of metrics, prompts, offers, surveys, or presentations. By combining the use of one or more of a table, rules or AI based system, including, for example, as disclosed in the applications incorporated by reference herein, a more effective marketing system may be developed and deployed that achieves optimal or nearly optimal results over both the short and long term, without generally becoming static.

In one embodiment, the present invention tests customers of one or more locations using discounts or other marketing offers, while maintaining the regular prices at one or more other locations. By comparing the results data from such test and control groups of locations, the present invention can better determine which offers, discounts, etc., are accretive or provide net benefit or are subject to gaming, fishing or other fraudulent or undesirable activities. Such testing can be performed within a single unit as well, by periodically making and not making such offers to the same or similar customers or by randomly providing such offers or not making such offers. In another embodiment, the present invention makes use of a combination of such testing methodologies in order to best determine which offers yield optimal or the best results given the present invention information, parameters or any one or more customer, business, sponsor or present invention objectives. For example, the present invention tests in a single or group of stores certain new or untested offers, and, combines such test with a periodic offer, for example, toggling, between making and not making offers, which toggling, may be random, 50/50, or may be intelligently determined based upon system information, and continue such test for a period of time, for example, one month, while comparing results of such tests with a similar number of stores in a control group, and then, switch the process, for example, test within the original control group and stop making offers within the original test group. In this fashion the present invention determines the effects of turning on or off certain offers or types of offers and the effect of such offers on customers, customer buying habits, store or business results, or any other measures, including, for example, testing for dilution, diversion, accretion, gaming or fishing.

In a further embodiment, a system administrator is permitted to enter or modify or delete or otherwise provide metrics, prompts, offers, surveys, or presentations using an interface provided for such purposes. When establishing messages or content of metrics, prompts, offers, surveys, or presentations, such administrator or other end user may be further permitted to designate which metrics, prompts, offers, surveys, or presentations are to be generally used when using a particular type of communications. For example, one type of metric, prompt, offer, survey, or presentation may be designated for use when communicating via cell phone and another metric, prompt, offer, survey, or presentation for email and still other versions for each or all of the other various methods of communications. In one embodiment, the present invention tests each metric, prompt, offer, survey, or presentation with each such communications method to determine, partially or wholly, which metric, prompt, offer, survey, or presentation yields the best or optimal results over time or based upon any available information, including, for example, any available or otherwise accessible customer, business or sponsor information or objectives or by tracking actual activities and results or changes in behavior as expected or predicted by customers or other end users or classes or categories of uses or by device, location or payment method.

In one embodiment, metrics, prompts, offers, surveys, or presentations are determined or based upon any available information including, for example, one or more or any combination of any business objectives, or customer identification, customer information, customer objectives, or customer historic data such as buying habits, tendency to accept or reject any offers or similar offers, or based upon such acceptance with or without a discount, or the amount of or type of discount, willingness to accept specific items or classes of items, or whether or not such items are complementary to base order items, a usual, preferred, or last ordered items, general price elasticity as determined by prior ordering habits or those of similar customers, or classes of customers, or for a given store or location, or based upon the time of day, day of week, month, year, the weather, competitive information, such as information about current marketing campaigns, discounts, marketing offers, and like from one or more competitors.

The following is a listing of exemplary hardware and software that can be used in a present invention method or system. It should be understood that a present invention method or system is not limited to any or all of the hardware or software shown and that other hardware and software are included in the spirit and scope of the claimed invention.
1. Central System
   i.: Prompt and survey system. A central system can be managed by a central system for multiple retailers, or a single retailer can manage the system locally.
   ii. Survey and Prompt generation program.
   iii. Survey and Prompt management program-manages survey and prompt insertion into transaction flows.
   iv. Survey and Prompt modification program-modifies surveys and prompts based on performance results.
2. Retailer 1-n
   i. Survey and Prompt Offer Program-displays surveys and prompts generated by the central system. Also enables control of surveys and prompts locally, for example, a local administrator can set rules regarding prompts and surveys to be presented.
   ii. End User Device 1-n.

The following is a listing of exemplary data bases that can be used in a present invention method or system. It should be understood that a present invention method or system is not limited to any or all of the databases shown and that other databases are included in the spirit and scope of the claimed invention.
1. Employee Database: tracks employee information including survey and prompt performance.
2. Customer Database: tracks customer information including survey and prompt settings and performance.
3. Available Survey Database: stores available surveys.
4. Offer Survey Database: stores offers available with respect to prompts and surveys.
5. Survey Rules Database: stores rules that govern when and how surveys and prompts are generated.
6. Customer Rules Database: stores rules governing how surveys and prompts are generated for a specific customer.
7. Employee Rules Database: stores rules governing how surveys and prompts are generated for a specific employee.
8. Employee Score/Class/Rating Database: stores scores for employees that are used to classify certain employees as like other employees for survey and prompt generation.
9. Customer Score/Class/Rating Database: stores scores for customers that are used to classify certain customers as like other customers for survey and prompt generation.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A computer-based method for modifying a prompt or a survey, comprising:
receiving, using an interface element for at least one specially-programmed general purpose computer, an audio input including:
a response of an employee of a first business entity to at least one prompt presented to the employee; or,
a response of a customer of the first business entity to at least one question presented to the customer following a transaction between the customer and the first business entity;
storing the audio input in a memory unit for the at least one specially-programmed general purpose computer;
comparing the audio input to a first metric using a processor in the at least one specially-programmed general purpose computer;
modifying the at least one prompt or the at least one question using the processor, an artificial intelligence program (AIP) in the memory unit, and the comparison of the audio input with the first metric; and,
transmitting, using the interface element, the at least one prompt or the at least one question for presentation, on a respective display device, to the employee or the customer.

2. The method of claim 1 further comprising generating the first metric using the processor and the AIP.

3. The method of claim 1 wherein the first metric includes a second metric related to the employee or a third metric related to the customer and wherein comparing the audio input includes comparing the response of the employee to the second metric, or comparing the response of the customer to the third metric.

4. The method of claim 3 wherein the second or third metric includes input from the first customer regarding the at least one prompt.

5. The method of claim 4 wherein the input from the first customer includes a response to an interaction of the first customer and the first employee resulting from the implementation of the at least one prompt, and wherein modifying the at least one prompt includes eliminating or modifying a prompt from the at least one prompt according to the response, or wherein modifying the at least one question includes eliminating or modifying a question from the at least one question according to the response.

6. The method of claim 1 wherein the at least one prompt includes an upsell offer and the method further comprising generating or modifying the upsell offer using the processor and the AIP.

7. The method of claim 1 further comprising generating or modifying, using the processor and the AIP, a respective presentation for the at least one prompt, or for the at least one question.

8. The method of claim 1 further comprising:
storing, in the memory unit historical data selected from the group consisting of: historical data regarding prompts presented to at least one employee of the first business entity; historical data regarding questions presented to at least one customer of the first business entity; historical data regarding upsell offers, the historical data including acceptance rates of previous upsell offers or financial considerations, with respect to the first business entity, of previous upsell offers; historical data regarding performance of the at least one employee with respect to the first business entity, the historical data including previous compliance of the at least one employee with respect to previously presented prompts, or financial considerations, with respect to the first business entity, of prompts previously available for presentation by the at least one employee; and data regarding a purchasing history for the at least one customer; and,
the method further comprising generating or modifying the first metric using the processor, the AI program, and the historical data; or,
wherein modifying the at least one prompt or the at least one question includes using the historical data; or,
the method further comprising generating the at least one prompt or the at least one question using the processor, the AI program, and the historical data; or,
wherein the at least one prompt includes an upsell offer and the method further comprising using the processor, the AI program, and the historical data to generate or modify the upsell offer; or,
the method further comprising generating or modifying, using the processor, the AIP, and the historical data, a respective presentation for the at least one prompt, or for the at least one question.

9. The method of claim 8 wherein the historical data regarding prompts presented to at least one employee of the first business entity includes comparison of the prompts with respect to the first metric, or wherein historical data regarding questions presented to at least one customer of the first business entity includes comparison of the questions with respect to the first metric.

10. The method of claim 8 further comprising the steps of:
receiving, using the interface element, at least one rule from a wireless communications device (WCD) or from a general-purpose computer associated with a second business entity;
storing the at least one rule in the memory element; and,
modifying the first metric, the at least one prompt, the at least one question, or the respective presentation using the processor and the at least one rule.

11. The method of claim 10 wherein the first and second business entities are the same.

12. The method of claim 8 wherein the respective display device for the at least one question is a WCD and the method further comprising:
storing at least one rule in a memory element for the WCD; and,
executing, using a processor in the WCD, the at least one question or the respective presentation for the at least one question according to the at least one rule.

13. The method of claim 1 further comprising the steps of:
receiving, using the interface element, at least one rule from a WCD or from a general-purpose computer associated with a second business entity;
storing the at least one rule in the memory element;
modifying the at least one prompt or the at least one question using the processor and the at least one rule; and,
transmitting, using the interface element, the modified at least one prompt or the modified at least one question for display on the respective display device.

14. The method of claim 13 wherein the first and second business entities are the same.

15. The method of claim 1 wherein the respective display device for the at least one question is a WCD and the method further comprising:
storing at least one rule in a memory element for the WCD; and,
executing, using a processor in the WCD, the at least one question according to the at least one rule.

16. A system for modifying a prompt or a survey, comprising:
an interface element for at least one specially programmed general-purpose computer for receiving an audio input including:
a response of an employee of a first business entity to at least one prompt presented to the employee; or,
a response of a customer of the first business entity to at least one question presented to the customer following a transaction between the customer and the first business entity;
a memory unit for the at least one specially programmed general-purpose computer for storing an artificial intelligence program (AIP); and,
a processor for the at least one specially programmed general-purpose computer for:
storing the audio input in the memory unit;
comparing the audio input to a first metric;
modifying the at least one prompt or the at least one question using the AIP and the comparison of the audio input with the first metric; and,
transmitting, using the interface element, the at least one prompt or the at least one question for presentation, on a respective display device, to the employee or the customer.

17. The system of claim 16 wherein the processor is for generating the first metric using the AIP.

18. The system of claim 16 wherein the first metric includes a second metric related to the employee or a third metric related to the customer and wherein the processor is for comparing the response of the employee to the second metric, or comparing the response of the customer to the third metric.

19. The system of claim 18 wherein the second or third metric includes input from the first customer regarding the at least one prompt.

20. The system of claim 19 wherein the input from the first customer includes a response to an interaction of the first customer and the first employee resulting from the implementation of the at least one prompt, and wherein the processor is for eliminating or modifying a prompt from the at least one prompt according to the response, or eliminating or modifying a question from the at least one question according to the response.

21. The system of claim 16 wherein the at least one prompt includes an upsell offer and wherein the processor is for generating or modifying the upsell offer using the AIP.

22. The system of claim 16 wherein the processor is for generating or modifying, using the AIP, a respective presentation for the at least one prompt, or for the at least one question.

23. The system of claim 16 wherein the processor is for:
storing, in the memory unit historical data selected from the group consisting of: historical data regarding prompts presented to at least one employee of the first business entity; historical data regarding questions presented to at least one customer of the first business entity; historical data regarding upsell offers, the historical data including acceptance rates of previous upsell offers or financial considerations, with respect to the first business entity, of previous upsell offers; historical data regarding performance of the at least one employee with respect to the first business entity, the historical data including previous compliance of the at least one employee with respect to previously presented prompts, or financial considerations, with respect to the first business entity, of prompts previously available for presentation by the at least one employee; and data regarding a purchasing history for the at least one customer; and,
wherein the processor is for generating or modifying the first metric using the processor, the AI program, and the historical data; or,
wherein the processor is for modifying the at least one prompt or the at least one question using the historical data; or,
wherein the processor is for generating the at least one prompt or the at least one question using the AI program and the historical data; or,
wherein the at least one prompt includes an upsell offer and wherein the processor is for using the AI program and the historical data to generate or modify the upsell offer; or,
wherein the processor is for generating or modifying, using the AIP and the historical data, a respective presentation for the at least one prompt, or for the at least one question.

24. The system of claim 23 wherein the historical data regarding prompts presented to at least one employee of the first business entity includes comparison of the prompts with respect to the first metric, or wherein historical data regarding questions presented to at least one customer of the first business entity includes comparison of the questions with respect to the first metric.

25. The system of claim 23 wherein the processor is for:
receiving, using the interface element, at least one rule from a wireless communications device (WCD) or from a general-purpose computer associated with a second business entity;
storing the at least one rule in the memory element; and,
modifying the first metric, the at least one prompt, the at least one question, or the respective presentation using the processor and the at least one rule.

26. The system of claim 25 wherein the first and second business entities are the same.

27. The system of claim 23 wherein the respective display device for the at least one question is a WCD with a memory element and a processor and the WCD is arranged to:
store at least one rule in a memory element for the WCD; and,
execute, using the processor in the WCD, the at least one question or the respective presentation for the at least one question according to the at least one rule.

28. The system of claim 16 wherein the processor is for:
receiving, using the interface element, at least one rule from a wireless communications device (WCD) or from a general-purpose computer associated with a second business entity;
storing the at least one rule in the memory element;
modifying the at least one prompt or the at least one question using the at least one rule; and,
transmitting, using the interface element, the modified at least one prompt or the modified at least one question for display on the respective display device.

29. The system of claim 28 wherein the first and second business entities are the same.

30. The system of claim 16 wherein the respective display device for the at least one question is a WCD with a memory element and a processor and the WCD is arranged to:
store at least one rule in a memory element for the WCD; and,
execute, using a processor in the WCD, the at least one question according to the at least one rule.
